(19) United States
(12) Patent Application Publication
(10) Pub. No.: US 2026/0092489 A1
(43) Pub. Date: Apr. 2, 2026

(54) Safe Box

(71) Applicant: Andrea Dal Farra, Arlington, VA (US)

(72) Inventor: Andrea Dal Farra, Arlington, VA (US)

(21) Appl. No.: 19/383,387

(22) Filed: Nov. 7, 2025

Related U.S. Application Data
(63) Continuation-in-part of application No. 18/196,726, filed on May 12, 2023, now abandoned.
(60) Provisional application No. 63/342,585, filed on May 16, 2022.

(51) Int. Cl. E05G 1/10; E05G 1/00; E05G 1/026; E05G 1/14

(52) U.S. Cl. CPC E05G 1/10; E05G 1/005; E05G 1/026; E05G 1/14; E05G 2700/04

(57) ABSTRACT

A secure shipping device is disclosed. The shipping device includes a hollow base having an opening and a door sized to overlay the opening. The device includes an electronic circuit board disposed in the door, and a G-force sensor, a GPS module, and a locking system, each of which is separately operatively connected to the electronic circuit board.

### REFERENCE TO RELATED APPLICATIONS

The present Nonprovisional Patent Application is a continuation-in-part (“CIP”) of U.S. Nonprovisional patent application Ser. No. 18/196,726 filed May 12, 2023, which, in turn, is based on United States Provisional Patent Application Ser. No. 63/342,585 filed May 16, 2022, the priority of both of which are hereby incorporated by reference for purposes of priority pursuant to Title 35, United States Code, Section 120.

### FIELD

The present subject matter is directed, in general to the field of safe boxes, and is directed more particularly to the field of safe boxes that are adapted and configured to include a real-time tracking system for operatively recording parcel shipment and delivery.

### BACKGROUND

US 2012/0298018 to McCabe discloses a portable safe configured to be temporarily secured to an object without requiring a user to monitor the safe or valuable items secured within. US 2022/0225810 to Mack discloses a weatherproof box defining a body having a top lid and including an airtight seal between the top lid and the body of the box to prevent liquids outside the box from getting inside. The weatherproof box is said to be used for safely and securely protecting one or more delivered packages when a package-delivery recipient cannot take possession of package delivery. So-called “safe” features (e.g., a key and a custom code to access the delivered packages) are disclosed.

WO 2018/222157 discloses a system for transferring money, gold, jewelry, and other valuable articles, characterized in that, the system comprises a product box having a password screen, within which box the noted valuables are placed, wherein the box includes a GPS system to provide information regarding location of the box and carrier vehicle information, wherein the box includes a camera to provide visual monitoring of the noted valuables, wherein the box also includes a biometric reader adapted and configured to identify the money, gold, jewelry, and other valuable articles inside said product box.

U.S. Pat. No. 8,009,034 to Dobson et al. discloses a security system for freight containers. The security system comprises a locking device to attach to the container and prevent unauthorized opening of container doors. The security system includes a sensing device to sense conditions affecting the container. The security system also includes a communication system to transmit sensing device output to an administrator located remotely from the container. The locking and sensing devices may be capable of two-way communication with the administrator. The administrator may interrogate the sensing device at selected times. The locking device may contain a GPS receiver whereby its geographic location at various times is monitored either continuously, periodically, or after a trip is completed. The security system may include a visual display on the exterior of the container to display selected messages. The messages could be preprogrammed or could be changed when the container moves from one geographic location to another.

U.S. Pat. No. 8,981,953 to Blaufuss discloses a protection module, a system, and a method for monitoring objects. The protection module includes a locating module for acquiring position data of the protection module. The protection module further includes a communication unit which can send data to a monitoring device. The protection module can be placed in an “alarm state” by an alarm signal and, when in an alarm state, the protection module is said to be able to send position data to the monitoring device either in a predetermined alarm interval or continuously. U.S. Pat. No. 9,483,889 to Notheis et al. discloses a method to control an electronically secured device by means of a transponder.

U.S. Pat. No. 11,521,156 to Pacheo et al. discloses delivery of a product using a package with a printed label having a unique product ID, an RFID marker applied to the product that contains the ID, and a smart chip inside the product that contains the ID and a digital key. The ID from the RFID marker is compared to the label for initial validation of the package. The smart chip is further interrogated to generate an encoded value of the ID, such as a hash value, using the digital key. The hash value is then used to authenticate the ID, thereby verifying that the product as delivered is the original, untampered product. The product ID and the hash value are recorded in a blockchain ledger associated with the product. In this manner, the packaged product can be validated by any party in the delivery chain including, e.g., a manufacturer, a seller, a distributor, a delivery service, and final recipient. U.S. Pat. No. 11,631,043 to Caterino et al. discloses Methods and system for securing delivery of a parcel when an intended recipient is unavailable, comprising at least one storage receptacle having an electronically controlled locking mechanism, the storage receptacle comprising an interface for receiving an access code for facilitating unlocking of the storage receptacle, a wireless communication radio, and a processor. The system further comprises a remote service manager comprising an access code generator and a wireless communication radio for transmitting an access code to a mobile computing device operated by a delivery carrier. The mobile computing device includes a wireless communication radio, one or more processors, and a memory comprising instructions which, when executed by the one or more processors, cause the one or more processors to: receive, via the wireless communication radio, from the remote service manager, a single use access code for facilitating unlocking of the storage receptacle, and transmit the access code to the storage receptacle interface. The storage receptacle processor confirms the validity of the access code and causes the storage receptacle to first unlock and then lock the receptacle after the parcel within the receptacle is detected.

U.S. Pat. No. 11,922,365 to Kunjukrishnan discloses a portable device configured to augment a shipping container with security and communications capabilities. The device includes multiple sensors, communications circuitry, and other electronic circuitry and/or mechanical components. The device can determine, based on output of the multiple sensors, an anomalous event experienced by the shipping container relative to an expected activity and communicate an indication of the anomalous event over a wireless network to a remote computer. The device also performs an action either in response to the anomalous event or based on a command received from the remote computer. US 2012/0247373 to Van Dessel discloses a protection unit for use in or as a secured container, comprising a compartment for storage of valuables, a detection unit, a track-and-trace unit, and a foam-generating unit comprising either a quick-expanding and quick-hardening foam or a sticky foam. Detection by the detection unit of an unallowed event triggers operation of the track-and-trace unit and the foam-generating unit for trapping the operational track-and-trace unit as well as the valuables within a block of foam. Electronic components for track-and-trace operation may comprise a module for transmission via either telecommunication or internet of its position to a remote receiver.

US 2019/0359400 to Pariente-Cohen et al. discloses a shipping box system and method, in which a shipping box has a container having a bottom surface and a plurality of walls. The container walls form a first perimeter about a container cavity. The shipping box further has a lid having a top surface and walls. The lid walls form a second perimeter about a lid cavity. The box further provides: (1) a sensor module for determining physical location and orientation of the container, (2) a computations module for evaluating data retrieved from the sensor module, and (3) a locking assembly for locking the container and the lid in a closed configuration. The container and the lid are dimensioned to nest, such that when the lid is fixed to the container, the container cavity and the lid cavity occupy substantially the same space, so that the container walls and the lid walls overlap.

US 2020/0051015 to Davis et al. disclose a shipping package including an enclosure for receiving content within. The shipping package also includes a closure for sealing the enclosure, a label having shipping information, a network module, a sensor module, and a battery module. The battery module provides power to the network module and the sensor module. The sensor module provides location information to the network module. The network module transmits a shipping status message to an external device.

US2021/0312387 to Estill et al. discloses a system for parcel transport and tracking. The system operates in response to data-bearing records. The system includes a plurality of geographically spaced-apart repositories. Exemplary repositories include one or more enclosed compartments. Access to each enclosed compartment is controlled by a door operatively connected to an associated lock. Circuits of a central system are, in turn, operatively connected to the repositories for controlling access to compartments and for causing the compartments to be selectively accessible so that selected parcels may be stored in a compartment for retrieval by people authorized to access parcels therefrom. In exemplary arrangements, central system circuitry is operative to determine bundles of parcels to be transported between respective repositories to facilitate delivery of the parcels to their associated delivery locations. US 2023/0407698 to Cimo discloses a security system for storing a plurality of valuables. The system includes a body for holding the plurality of valuables. The system includes a lid coupled to the body and movable between a closed position for securely storing the plurality of valuables and an open position for accessing at least one of the plurality of valuables. The system includes a locking mechanism, components of which provide an unlocked state corresponding to when the lid is movable between the closed and open positions, and a locked state corresponding to when the lid is held in the closed position. The system includes an interface apparatus coupled to at least one of the body and lid. Responsive to a wireless signal from a user input device, the interface apparatus will cause the locking mechanism to be moved from the locked state to the unlocked state, for allowing the lid to be moved to the open position, whereby at least one of the plurality of valuables may be accessed.

Conventional package tracking is well known in the art, being used by postal services, couriers, and other shipping and delivery services, to determine the location of a package. A package, or box is given a tracking number or code when it is provided by a sender to a delivery service. Typically, a barcode is affixed to the package and may be scanned with an optical reader. Alternatively, other technology such as magnetic strips, a radio-frequency identification (“RFID”) or a near-field communication (“NFC”) tag is used.

At key points along the journey to its destination, the package is scanned, with the location and progress of the package made available by a barcode. When delivered to a recipient, a package is scanned, and a recipient may also need to provide a signature.

Presently used technology has several drawbacks. One is that packages are only scanned at predefined points in their journey. Another is that once a package is marked as delivered, it is no longer tracked. If delivered to an incorrect location or signed for by an incorrect recipient, it is easy for a package to become lost. Also, if a package is opened on route, or tampered with, such activity is not detected by its scanning process.

With package theft becoming an increasing issue, there is currently no way for a sending or receiving party or shipping company to verify whether a person picking up a package is an authorized courier or receiving party or to identify who opened a package after it was delivered. In addition to package theft, with the continuing growth in Internet retail, e-commerce, overnight shipping and same day delivery, there is also an increase in misplaced packages and package returns and there is presently no way to automatically re-route in-route packages other than to return the package to the sender.

Existing wireless package identification systems such as Radio Frequency Identification (RFID) tags and Near Field Communication (NFC) indicia are limited in the amount of data that may be transmitted as well as the signal strength and close proximity necessary to receive the RFID or NFC signal. Moreover, both have significant limitations in real-time data, self-tracking, self-reporting, and in peer-to-peer networking capabilities.

There are a few solutions for shipping valuable items. Some of these solutions attempt to offer geo-localization of the package, but these solutions generally fail to meet the needs of the industry because they do not offer a theft-proof case and anti-theft system. Moreover, the packaging is often too weak to secure items or too easy to open.

Existing package tracking and networking systems including but not limited to GPS tracking devices that may be placed inside of a package to continuously monitor package location may not include motion, shock, temperature or other physical-property sensors or may not have wireless data uploading capabilities via a Cellular or a LAN network designed to track a single package with limited or no peer-to-peer wireless package networking, or may not have identification or verification capabilities or may not have any package monitoring, audio-video, data streaming, bi-directional or multi-channel communications or they may not have an anti-theft system or a monitored locking system.

Other prior art solutions may attempt to offer security cases, but these solutions are similarly unable to meet the needs of the industry because they do not offer real-time data (location and status) and the carrier portals are often not updated with accurate data.

While the above-described prior art may meet certain requirements, the patents and applications mentioned above do not describe a network that allows for tracking and/or monitoring of a package using detection and notification systems that ensure that the packages are safely delivered to predetermined recipients. Nor do the patents and applications mentioned above offer a level of protection that would combine an anti-theft system with a monitored-locking system. There is therefore a need for a cost-effective protected-package system that combines active-tracking and tamper-detection systems with an anti-theft system to improve security and reliability of valuable item shipments.

To solve this problem, the safe box of the present subject matter is a combination comprising a safe box equipped with an anti-theft system to ship valuable items. The safe box includes an electronic circuit board adapted and configured to control and transmit the status and location of the safe box to a remotely located center in real time through a networked data communication system adapted and configured to ensure shipper control over every aspect of a shipment and peace of mind when shipping high valuable items.

### SUMMARY

In view of the foregoing disadvantages in the prior art, a safe box of the present subject matter provides not only a secure shipping solution for high value items, but also overcomes one or more above-noted disadvantages and/or drawbacks of the prior art. Accordingly, one purpose of the present subject matter, described in greater detail below, is to provide reusable, secure-shipping packaging that includes tracking and monitoring systems, and anti-theft systems adapted and configured to provide in a shipping package (i.e., in a safe box) adapted and configured to include tracking and/or monitoring systems.

Thus there is a need for a safe box having a real-time tracking system to allow shippers to track valuable items during shipment and securely deliver the items. As used throughout this specification, the term “real time” shall be understood to mean the actual time during which something takes place. (Example: He watched events unfolding in real time on TV.) Moreover, it would be desirable to have a safe box with a tracking system that allows control of the location of a package and the status of the package in real time.

There is also a need for a safe box to include a tracking system adapted and configured to allow a user to protect and secure items during shipment with a high level of protection. A safe box of the present subject matter advantageously fills these needs and addresses above-noted deficiencies by providing sturdy packaging with an anti-theft system adapted and configured to allow a sender to monitor and secure the valuable items during the shipping period until the items are delivered to a predetermined recipient.

The safe box of the present subject matter includes a tracking device made up of the following components: a base (a secure container into which the valuable items to be shipped are placed). The safe box includes a lid (including electronic components and sensors, and an anti-theft system and a monitored locking system). These components are related to each other as follows: a shipping package (i.e., the safe box) comprises an enclosure (i.e., the base) sized, designed, adapted and configured to received items of various sizes. The safe box further includes a closure (i.e., a lid) sized, adapted, and configured to seal the enclosure (i.e., the safe box) with a network module, a sensor module, an anti-theft module, and a battery module. The battery module provides power to the network module and the sensor module. The sensor module provides location information and sensor data to the network module. The network module transmits shipping status and data messages to an external network. The external network May support one or more protocols as are known in the art including IEEE 802 Wi-Fi, cellular networks, Bluetooth, RFID, NFC, and others. Since the safe box is aware of its location, it can be adapted to automatically go into “airplane mode” when in an aircraft. It may be adapted to automatically disable wireless interfaces that are not required when in a vehicle, container, or building when in wireless contact with its immediate surroundings and using networking hardware in its surroundings as a router, an access point, or a hub.

In many cases, safe boxes may connect to a central server or service such as a shipping or delivery company. Such shipper, receiver, or other authorized parties May receive package status updates either directly from the safe box, via a package tracking website, platform, software application, or through a shipping company website. Updates, status changes, and alerts may be queried by external networked devices, be reported by the safe box itself, be logged locally or remotely, or a combination of these methods.

The lid hosts several sensors, including but not limited to a GPS sensor, a light sensor (to alert of unpacking), an anti-theft device, a microphone (to register voices in case of theft), a speaker (to play and/or record voice and to sound alarm messages), a camera (to reveal faces in real time and to record faces in case of theft), a wireless base charger to charge the battery if the level of charge is low, a key socket to open the lid in case of electronic failure, a reset button in case a software reboot is necessary, a touchscreen display, adapted and configured to display alarms or a pin pad indicating where to tap a password to unlock the device, for enabling users to interface with the touchscreen display. The lid is adapted to include a G-force sensor to detect tampering.

The safe box will be electronically operated. Power is supplied by a rechargeable battery. Any detected theft of a package being shipped can also trigger events, such as the disabling of electronics in the packaged device, the activation of alert systems and the anti-theft system, including audible or light alarms on or in the packaging, or in the carrying vehicle or storage space, or alert transmission via Cellular, Wi-Fi, Bluetooth, NFC or other remote, wide area, local area and/or short-distance means to local security or carrier staff or to other agents via the Internet, or the automatic transmission of an IP address and/or GPS coordinates of a thief over a network by the stolen devices, as soon as information corresponding to a triggering event is connected to the internet, wherein the safe box is not a generic Internet-of-Things (“IOT”) accessory but rather a purpose-built secure-shipping device exhibiting restricted, policy-driven communication behavior. An alert transmission may also be triggered if a package leaves its pre-assigned travel route or is assigned to intermittently send out transmissions at pre-selected time intervals or at pre-set locations for the packages. A shipper or shipping company may assign the shipping and destination locations or additional shipping information such as air, ground, and/or sea routes and/or may assign designated shipping centers and methods such as which airplane, delivery truck and or delivery agent the package is assigned to, and any changes in the shipping route, method or delivery agent will automatically trigger an alert.

In certain embodiments, the safe box may include one or more of the following components: a plurality of bases sized to fit an associated plurality of different-sized packaging from each courier. The safe box may include an internal camera to witness in real time and record the insertion of items into the safe box until the lid is secured. The safe box may include a lock electronically monitored to control that it shall remain closed until unpacking of the safe box is authorized. The safe box may include a waterproof and/or a bulletproof case material. The safe box may include a fireproof case material. The safe box may also include a speaker adapted and configured to provide instructions to a person in the vicinity or for other purposes. When combined with a microphone, the speaker may allow for voice communication between and among a shipper, a receiver, a service provider and other interested or authorized parties. The safe box may also include an anti-theft system that deploys ink or that emits smoke or anti-theft foam. The safe box may also include an anti-jammer device to protect the GPS and data transmission against jamming. The safe box is thus structurally different from other known devices or solutions.

This disclosure shall now provide a more detailed description that shall refer to the accompanying drawings. The drawings and associated description of the drawings, as well as any specific or alternative embodiments discussed, are intended to be read in conjunction with the entirety of this disclosure. The safe box of the present subject matter with real time tracking system for parcel shipment may, however, be embodied in many different forms and should not be construed as being limited to the embodiments set forth herein. Rather, while embodiments are provided for illustrative purposes, this disclosure will be thorough, complete, and shall convey full understanding to those skilled in the art.

### BRIEF DESCRIPTION OF THE DRAWING FIGURES

FIG. 1 depicts a front perspective view of an embodiment of a smart shipping device (also referred to as a safe box above) illustrating its general external configuration.

FIG. 2 depicts the front perspective view of FIG. 1, with its internal region partially revealed, due to an upwardly disposed orientation of a door revealing the internal region.

FIG. 3 is a partially exploded perspective view of an embodiment of the smart shipping device (also referred to as a safe box above) presented in FIGS. 1 and 2, where the smart shipping device comprises a door or cover and a rectangular base or container, where FIG. 3 depicts the door or cover spaced above the rectangular base or container.

FIG. 4 is another exploded perspective view of the smart shipping device depicting various electronic, electromechanical, and structural components for the device.

FIG. 5 is a front perspective view of embodiments of a plurality of different-sized bases for the smart shipping device (also safe box above) of the present subject matter.

FIG. 6 is a front perspective view showing an outer shipping carton arrangement depicting a relationship between the smart shipping device and the outer shipping carton.

Throughout the FIGS. and detailed description of this patent application, similar reference numerals are used to refer to related components of the present subject matter.

### DETAILED DESCRIPTION

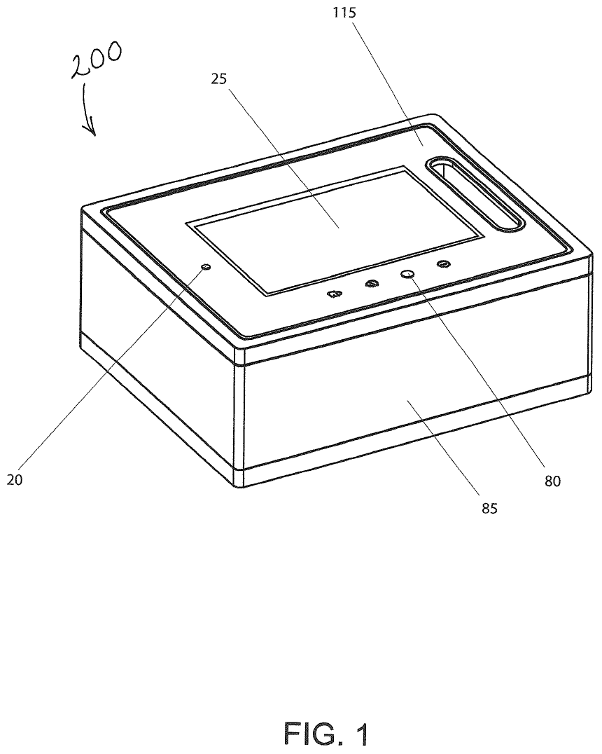

Referring to FIG. 1, a front perspective view of the smart shipping device (also referred to as a safe box above) 200 of the present subject matter, includes a hollowed rectangular base or container 85 and associated door or cover 115. The door or cover 115 includes an outwardly oriented display and touch screen 25. The door or cover 115 further includes a first opening 20 for a lens of a camera and a second opening 80 for a light sensor. The light sensor and the camera and its lens are contained within door 115.

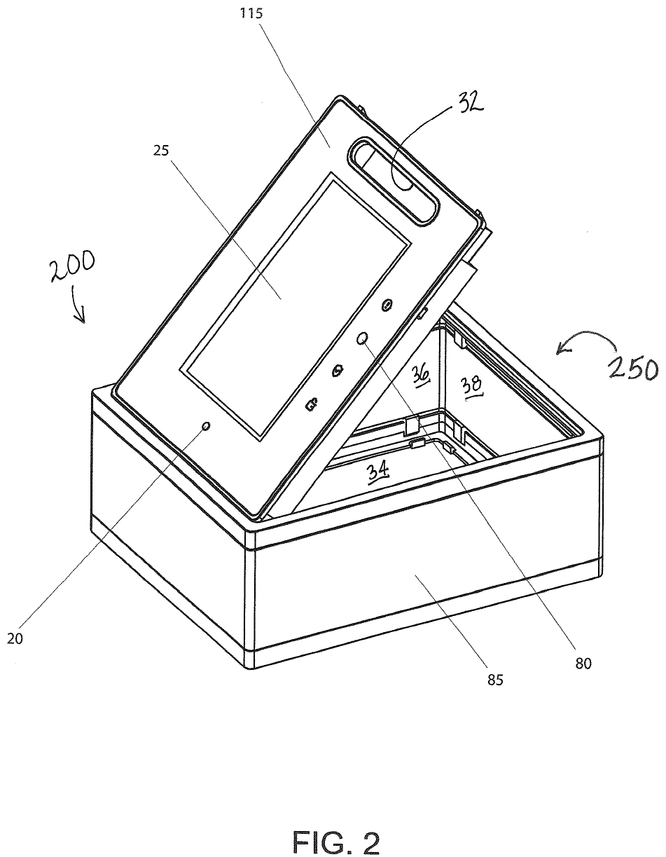

Referring to FIG. 2, an elongated depression 32 disposed along an upper end portion of the door or cover 115 is sized, adapted, and configured to enable a user to grasp the depression 32 to pivot the door or cover 115 along an edge portion of the door or cover 115 spaced from the depression 32, whereby the depression 32 may be grasped by a user to expose a floor 34, an inner longer wall 36, an inner shorter wall 38, and a portion of an opening 250 for hollow base or container 85 of smart shipping device 200.

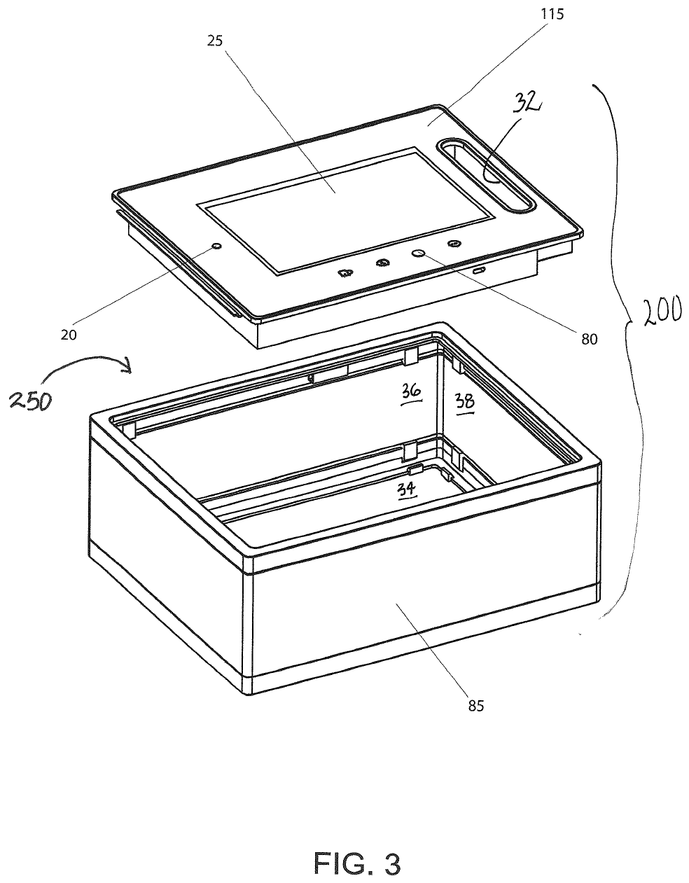

Referring to FIG. 3, a front perspective view of smart shipping device 200 with the door or cover 115 spaced above the opening of the base or container 85 of the smart shipping device 200 presents an internal view of the base or container 85 of device 200.

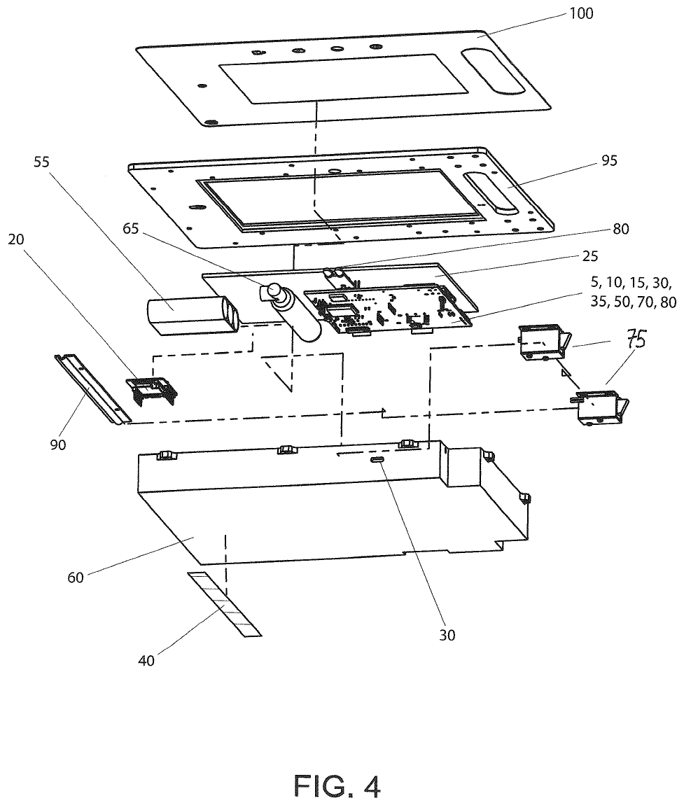

Referring now to FIG. 4 there is shown an exploded perspective view of a secure electronic shipping device 200 (called a smart shipping device 200 or safe box above) presenting the interaction and functional relationship between its various components. The device 200 generally comprises a plurality of electronic, electromechanical, and structural elements configured to cooperatively provide tamper detection, environmental monitoring, communication, and controlled access to a secured internal compartment.

The device 200 includes a microphone 5 operatively connected to an electronic circuit board 70 through a two-wire connection (not shown). The microphone 5 captures ambient audio signals within or adjacent to the device base or enclosure 85 for the purpose of detecting and recording suspicious sound events or verifying tamper activity. A captured analog signal (of an ambient audio signal) is transmitted to the electronic board for digitization and further processing. In some embodiments of the present subject matter, the microphone 5 is configured to record audio evidence when unauthorized access or a theft event is detected, whereby the system 200 documents environmental sounds and/or voices associated with each incident for evidentiary and security purposes.

A charger 10 is provided to deliver regulated electrical current to a battery 55 for energy replenishment. The battery 55 is also operatively connected to the electronic circuit board 70 through a two-wire connection (not shown). Charger 10 communicates with the electronic circuit board 70 through a two-wire interface, enabling charge control and monitoring functions. In embodiments, the battery 55 may be recharged either through a wired connection or wirelessly, by means of an inductive coil or solenoid assembly installed internally within the housing of the secure electronic shipping device 200, thereby allowing convenient charging of the device 200, without the need for direct electrical contact, which also serves to improve environmental sealing during transport.

A speaker 15 is operatively connected to the electronic circuit board 70 via a two-wire line (not shown) and is adapted and configured to emit audible alerts or notifications in response to system events or user commands. Speaker 15 allows device 200 to generate sound-based warnings and/or acknowledgment tones during operation.

A camera 20 is communicatively linked to the electronic circuit board 70 through a UART connection (not shown). The camera 20 captures still or video images of the internal compartment and transmits such data to the electronic circuit board 70 for storage, encryption, or external communication. The camera 20 thereby assists in documenting the status of contents of the housing of electronic shipping device 200 during transport. In embodiments, camera 20 is adapted and configured to record images or video of either the interior or exterior of shipping device 200, depending on operational mode. When detecting a tamper event or unauthorized access, the camera 20 may automatically activate external imaging to capture visual evidence of the incident, to document the circumstances surrounding the event for later verification or investigation.

A touchscreen display 25 serves as the principal human-to-machine interface. The display 25 communicates with the electronic circuit board 70 via an SPI cable and provides visual information including but not limited to operational status, alerts, and tracking data. The touch input permits a user to configure shipment parameters or initiate commands directly through the interface. In alternative embodiments, the user interface may be implemented through one or more external capacitive buttons or touch-sensitive zones positioned adjacent to display screen 25, enabling navigation and command input without requiring a full touch-screen panel. Such configurations provide simplified interaction while maintaining sealed and durable operation under varying environmental conditions. In embodiments, display 25 is configured to function as a dynamic electronic shipping label, able to present barcode, QR code, or textual shipment information directly on the screen 25. This feature eliminates a need for traditional printed labels, reducing material waste and enabling real-time updates of carrier, recipient, and/or tracking data.

A reset button 30 is operatively coupled to the electronic circuit board 70 via two wires (not shown), for enabling manual system restart and/or firmware reset, thereby providing recovery capability in case of a system malfunction and/or a software error.

A GPS module 35 communicates with the electronic circuit board 70 through a UART interface to determine real-time geolocation data. The GPS continuously reports positional information, allowing device 200 to track and log its location during transport.

Heating pads 40 are connected to the electronic circuit board 70 by two wires (not shown). The heating pads 40 are adapted and configured to maintain a stable internal temperature environment. The pads 40 are automatically activated when temperature thresholds are detected by the device 200, protecting thermally sensitive shipments.

A G-force sensor 50 is operatively connected to circuit board 70 by means of an I2C communication bus. The sensor 50 is adapted and configured to detect acceleration, impact, and/or vibration forces acting on shipping device 200 and provides corresponding digital data to electronic circuit board 70 for shock event analysis and tamper detection.

The battery 55 supplies electrical energy to the electronic circuit board 70 and all its associated components. Battery 55 is linked to electronic circuit board 70 through two wires (not shown) and is charged via the charger 10 when external power is applied.

An anti-theft foam dispenser 65 is operatively connected to the electronic circuit board 70 by two wires. Upon receipt of a triggering signal from the electronic circuit board 70, dispenser 65 releases an expanding foam material intended to immobilize or secure the internal contents in event of unauthorized access. In embodiments, the dispenser 65 may be configured to release different types of substances or compounds depending on the nature of the shipped item. For example, shipping device 200 may dispense a soft protective foam, a quick-hardening resin, or other material formulations specifically selected to cushion, isolate, or physically restrict movement of the contained object.

The electronic circuit board 70 functions as a central control and processing unit for the secure electronic shipping device 200. The circuit board 70 comprises circuitry for power regulation, microcontroller logic, communication interfaces, and data storage. The electronic circuit board 70 integrates inputs from all connected sensors and peripherals, executes firmware algorithms, and controls the cooperative behavior of the entire system.

A light sensor 80 is operatively coupled to the electronic circuit board 70 via a four-conductor connection providing power and signal transmission. Light sensor 80 detects changes in ambient illumination, enabling detection of outer-carton removal or unauthorized opening events. In embodiments, light sensor 80 may employ infrared, optical, or other detection technologies able to identify a presence or absence of the outer shipping carton. Such variations allow the system to reliably detect when external packaging has been opened, displaced, or tampered with, even under enclosed or low-light conditions, enhancing tamper-detection accuracy across shipping environments.

A locking system 90 is electrically coupled to the electronic circuit board 70 through a two-wire line (not shown). Locking system 90 mechanically secures door 115 to rectangular base or container 85 and is actuated by electrical signals from the electronic circuit board 70 upon user authentication or system authorization. In embodiments, locking system 90 comprises one or more electro-mechanical locks or solenoid-based latching mechanisms adapted and configured to cooperate with reinforced hinges (not shown) to ensure a stable and secure closure of door 115. Hinges maintain precise alignment between the door and the frame, while the electromechanical locks provide positive engagement and controlled release under authorized conditions, thereby enhancing both mechanical strength and tamper resistance. In embodiments, the locking system 90 comprises manual lock sockets 75 mechanically associated with the locking system 90. The lock sockets 75 allow for redundant physical locking by means of a mechanical key, thereby ensuring operability even in the absence of electrical power.

A lid cover 60 is mechanically assembled to a door frame 95 and is affixed by screws to protect internal components from physical impact and environmental exposure.

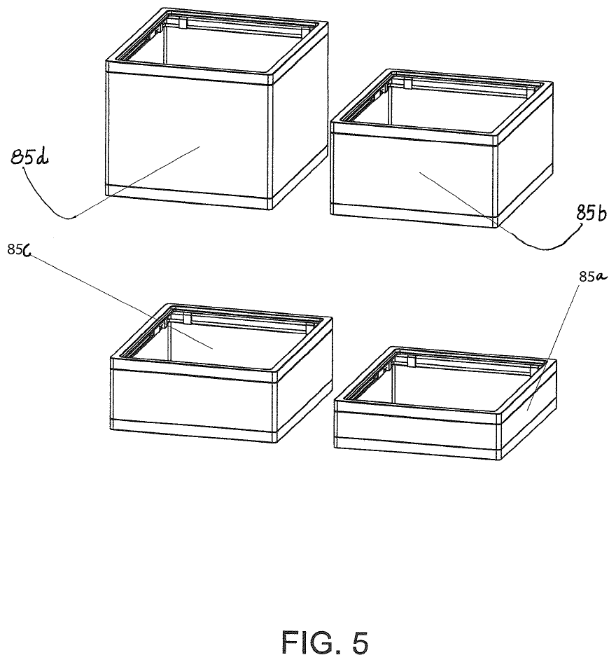

A base 85 (FIGS. 1-3) is sized, adapted and configured to form a lower structural portion of the secure electronic shipping device 200 and to provide physical support for the object or item being shipped. A base 85a, 85b, 85c, 85d is dimensioned, designed, adapted, and configured (FIG. 5) to accommodate various dimensional formats and internal volumes depending on size and nature of contents, while remaining standardized to interface with the same door opening and frame configuration. In certain embodiments, the base may include recessed areas, cushioning elements, or adjustable supports to stabilize and protect the shipped object during transport without directly housing any of the electronic assemblies of the device. In further embodiments, the base 85 might be constructed from of or reinforced with a bullet-resistant, a fire-resistant, or an otherwise impact-mitigating material, e.g., composite laminate, ballistic-grade polymer, or treated metal alloy. Such materials enhance structural protection of the secure electronic shipping device 200 and safeguard the shipped contents against external threats, extreme temperatures, and/or mechanical penetration during transport or attempted tampering.

The door frame 95 provides a rigid structural interface between the base 85 and door 115, for maintaining correct alignment and sealing engagement. The protection sheet 100 is positioned within the structure to absorb mechanical shock and safeguard internal electronics from vibration and/or impact forces. In embodiments, the protection sheet 100 additionally serves as a transparent or semi-transparent barrier that blocks water entry and provides dust protection while still allowing a user to view and operate touchscreen display 25 located below it. Such configuration ensures the entire interface use while maintaining environmental sealing and mechanical resilience during shipment.

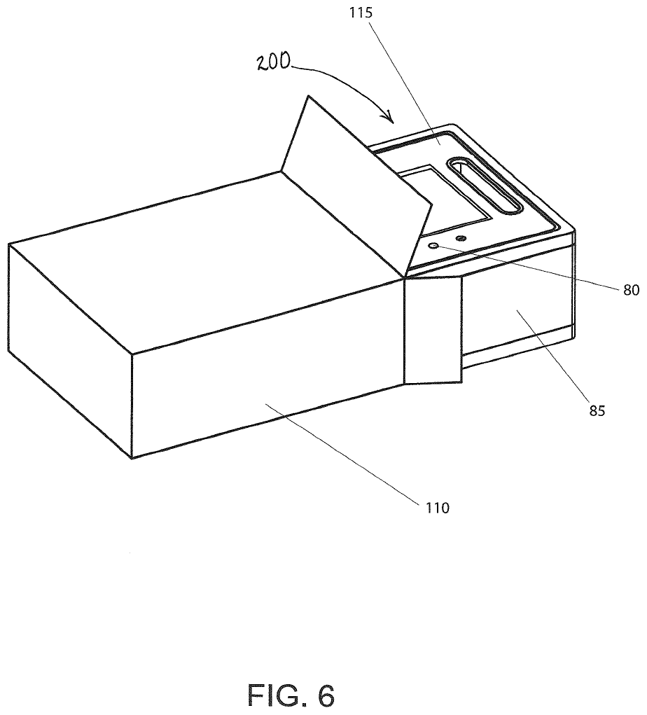

An outer shipping carton 110 (FIG. 6) encloses the assembled device 200 for transportation purposes. In cooperation with the light sensor 80 and motion sensors, the outer carton enables the system to detect unboxing or tampering events during shipment.

The door 115, as described herein, represents the assembly comprising all mechanical and electronic components of the secure electronic shipping device 200 exclusive of the base 85. This includes, but is not limited to, the door frame 95, locking system 90, the touchscreen display 25, sensors, and electronic board 70. The door 115 provides controlled access to the interior compartment and constitutes the active portion of the device 200 responsible for monitoring, control, and security functions. The door 115 interfaces mechanically with the base 85 through reinforced hinges and locking points and may incorporate sealing gaskets, protective coatings, or other environmental barriers to ensure the integrity of the enclosure against dust, moisture, and physical impact.

When assembled, components of the device 200 operate cooperatively under coordinated control of electronic circuit board 70, which functions as a central processing and management unit. The board receives continuous input from the various sensors 5, 20, 35, 50, 80 that collectively monitor environmental, positional, mechanical, and security conditions within and around the device 200. These sensors detect parameters such as ambient light intensity, acceleration, geographic position, acoustic activity, and video imagery, providing real-time data streams for event assessment and record generation.

Upon identifying predefined conditions or anomalies—such as sudden impact, unauthorized movement, temperature deviation, or removal of the outer shipping carton—the electronic circuit board 70 executes corresponding responses according to a programmed logic. Such responses may include activating the speaker 15 to emit audible alerts, triggering the anti-theft foam dispenser 65 to immobilize the contained object, or commanding the locking system 90 to engage or maintain a secured state. In certain embodiments, the electronic circuit board 70 may instruct the camera 20 and microphone 5 to record synchronized audiovisual evidence, for documenting the detected event.

The display 25, whether implemented as a touch screen or through capacitive navigation buttons, provides a user with real-time operational information including status indicators, sensor readings, connectivity conditions, and tracking data. Display 25 also enables user authentication, setup of shipment parameters, and interaction with system menus. In embodiments, the display 25 operates as a dynamic electronic shipping label, presenting digital carrier and destination information in lieu of printed documentation.

The battery 55 supplies continuous electrical power to all subsystems, while the charger 10 ensures replenishment either through wired or wireless inductive charging. Together, they maintain autonomous operation for extended durations during transit. The G-force sensor 50 and the GPS module 35 collaborate to log motion, vibration, and location data, allowing post-shipment analysis and verification of shipping integrity.

Structurally, the base 85 provides physical support for the shipped object, while the door assembly 115—comprising the mechanical and electronic components—serves as the active portion responsible for system management, sensing, and access control. The door frame 95 and locking system 90 maintain precise alignment and mechanical security, and the protection sheet 100 shields the internal assemblies from impact, water, and dust while permitting visibility and operation of the display. The outer shipping carton 110 encloses the entire device, cooperating with the light sensor 80 and related subsystems to enable tamper detection when the packaging is removed or disturbed.

Collectively, the electronic and mechanical components described in this patent specification establish a closed monitoring and protection ecosystem, configured to ensure high-value contents are continuously monitored, environmentally safeguarded, and securely contained throughout the entire shipping process. The electronic shipping device 200 thereby achieves dual objectives of mechanical robustness and electronic oversight, providing verifiable evidence of shipment integrity from origin to destination.

What has been described in detail throughout this patent specification and illustrated by the accompanying FIGS. is a secure electronic shipping device. While the present subject matter has been described with reference to exemplary embodiments, the present subject matter is not limited to the embodiments shown and described herein. On the contrary, alternatives, changes, and/or modifications will be apparent to a person of ordinary skill in the art after this patent specification and its FIGS. have been reviewed. Therefore, alternatives, changes, and/or modifications shall be treated as forming a part of the present subject matter insofar as they fall within the spirit and scope of the claims.

1. A secure shipping device (200) comprising:
a hollow base (85) defining an internal region and an opening sized, adapted, and configured to enable a preselected article to be inserted into the internal region;
a door (115) sized, adapted, and configured to overlay the opening;
an electronic circuit board (70) disposed within the door (115), wherein the circuit board (70) is operatively connected to a power source, and wherein the circuit board (70) is adapted and configured to function as a central control and processing unit for the shipping device (200);
a G-force sensor (50) operatively connected to the circuit board (70), wherein the G-force sensor (50) is adapted and configured to detect acceleration, impact, or vibration forces acting upon the device (200);
a GPS module (35) operatively connected with the circuit board (70), wherein the GPS module (35) is adapted and configured to determine real-time geolocation data associated with the shipping device (200); and
a locking system (90) operatively connected to the circuit board (70) for locking the door (115) to the opening, whereby the locking system (90) is adapted and configured to cause the door (115) to overlay the opening in a fluid-tight manner.

2. The secure shipping device (200) of claim 1, including a microphone (5) operatively connected to the circuit board (70), wherein the microphone (5) is configured to capture ambient audio signals adjacent to the shipping device (200) for detecting sound events near the device (200) or verifying tamper activity with the device (200).

3. The secure shipping device (200) of claim 1, including a camera (20) communicatively linked to the circuit board (70), wherein the camera (20) is adapted and configured to capture still or video images within the hollow base (85) and transmit the images to the circuit board (70) for storage, encryption, or external communication.

4. The secure shipping device (200) of claim 1, further including a light sensor (80) operatively coupled to the circuit board 70, wherein the light sensor 80 is adapted and configured to detect changes in ambient illumination, for detecting removal of the shipping device (200) from a shipping carton (110) containing the device (200).

5. The secure shipping device (200) of claim 1, including a speaker (15) operatively connected to the circuit board (70), wherein the speaker (15) is adapted and configured to emit audible alerts or notifications in response to user commands.

6. The secure shipping device (200) of claim 5, wherein the speaker (15) is configured to generate sound-based warnings and/or acknowledgment tones during operation.

7. The secure shipping device (200) of claim 1, including an anti-theft foam dispenser (65) operatively connected to the circuit board (70), wherein the dispenser (65) is adapted and configured to release an expanding foam material to immobilize or secure internal contents of the shipping device (200) in event of unauthorized access.

8. The secure shipping device (200) of claim 7, wherein the dispenser (65) is configured to dispense a soft protective foam, a quick-hardening resin, or other material formulations to cushion, isolate, or physically restrict movement of a contained object.
